(19) United States
(12) Patent Application Publication
(10) Pub. No.: US 2025/0322079 A1
(43) Pub. Date: Oct. 16, 2025

(54) SYSTEM AND METHOD FOR MONITORING AND MITIGATING DARK WEB DATA BREACHES

(71) Applicant: TALENT UNLIMITED ONLINE SERVICES PRIVATE LIMITED, Delhi (IN)

(72) Inventors: Aman Srivastava, Pratapgarh (IN); Akash Chaurasia, Varanasi (IN); Rahul Prasad, Gurugram (IN)

(21) Appl. No.: 18/736,556

(22) Filed: Jun. 7, 2024

(30) Foreign Application Priority Data
Apr. 11, 2024 (IN) 202411029529

(51) Int. Cl. G06F 21/57; G06F 21/53; G06F 21/55; H04L 9/40

(52) U.S. Cl. CPC G06F 21/577; G06F 21/53; G06F 21/552; G06F 21/554; H04L 63/0442

(57) ABSTRACT

Disclosed is a system (100). The system (100) includes a client device (101) and a host device (102). The host device (102) includes processing circuitry (120) that is configured to download files by way of file links, generate an isolated environment by way of a virtual non-transitory computer-readable medium such that the one or more files are received and processed in the isolated environment, generate a first mitigation signal when a data breach associated with the one or more files is detected. Based on the first mitigation signal (i) the virtual non-transitory computer-readable medium is compressed and encrypted and (ii) the generated isolated environment is deleted and generate a second mitigation signal when a data breach associated with the one or more files is not detected. Based on the second mitigation signal (i) the generated isolated environment is deleted and (ii) the virtual non-transitory computer-readable medium is deleted.

### TECHNICAL FIELD

The present disclosure relates to risk mitigation, and more particularly to a system and a method for monitoring and mitigating dark web data breaches.

### BACKGROUND

The advent of the internet has revolutionized communication, commerce, and various aspects of daily life. However, alongside its numerous benefits, the internet also harbours hidden realms known as the dark web. Unlike the surface web, which is indexed and accessible through traditional search engines, the dark web operates on encrypted networks, allowing users to remain anonymous and untraceable. This anonymity fosters a breeding ground for illicit activities, including but not limited to cybercrime, illegal trade, and dissemination of sensitive information.

The dark web poses significant challenges to law enforcement agencies, cybersecurity professionals, and businesses worldwide. Traditional monitoring techniques are ineffective in detecting and preventing malicious activities within these obscured networks. Moreover, the dynamic and decentralized nature of the dark web complicates efforts to identify emerging threats and trends, often leaving organizations vulnerable to cyberattacks and data breaches.

Existing solutions often lack a comprehensive authentication protocol, leaving systems vulnerable to third-party interference, even in the event of a compromised host. Secure file transfer mechanisms are critical, as conventional methods may be susceptible to host/data corruption or interception, compromising the integrity of the monitoring process.

Thus, to address the aforementioned problems, there remains a need for a technical solution to provide a system and a method for monitoring and mitigating dark web data breaches.

### SUMMARY

In an aspect of the present disclosure, a system is disclosed. The system includes a client device and a host device that is coupled to the client device. The host device includes processing circuitry. The processing circuitry is configured to: download one or more files by way of one or more file links. Further, the processing circuitry is configured to generate an isolated environment by way of a virtual non-transitory computer-readable medium such that the one or more files are received and processed in the isolated environment. Furthermore, the processing circuitry is configured to generate a first mitigation signal when a data breach associated with the one or more files is detected. Based on the first mitigation signal (i) the virtual non-transitory computer-readable medium is compressed and encrypted and (ii) the generated isolated environment is deleted. Furthermore, the processing circuitry is configured to generate a second mitigation signal when a data breach associated with the one or more files is not detected. Based on the second mitigation signal (i) the generated isolated environment is deleted and (ii) the virtual non-transitory computer-readable medium is deleted.

In some aspects of the present disclosure, the processing circuitry is configured to enable a handshake between the client device and the host device. To perform the handshake, the processing circuitry is configured to (i) receive one or more handshake signals from the client device and (ii) acknowledge the one or more handshake signals.

In some aspects of the present disclosure, the client device is configured to implement a bot that is configured to crawl one or more dark web channels to scrape information associated with one or more online forums, one or more marketplaces, stolen and/or breached data available on the dark web links.

In some aspects of the present disclosure, prior to the transmission of the one or more files to the virtual non-transitory computer-readable medium, the processing circuitry is configured to (i) break each file of the one or more files into a plurality of chunks, (ii) encrypt each chunk of the plurality of chunks by way of an asymmetric encryption technique to generate a plurality of encrypted chunks, and (iii) transfer each encrypted chunk of the plurality of encrypted chunks to the virtual non-transitory computer-readable medium one by one.

In some aspects of the present disclosure, to detect the data breach, the processing circuitry is configured to (i) implement a file processing engine by way of the virtual non-transitory computer-readable medium within the generated isolated environment, (ii) receive, by way of the file processing engine, the encrypted chunks, (ii) decrypt and assemble, by way of the file processing engine, the decrypted chunks into a file, and (iii) process, by way of the file processing engine, the file using file decompression and iterative keyword matching functions.

In some aspects of the present disclosure, to generate the isolated environment, the processing circuitry is configured to create the virtual non-transitory computer-readable medium having a size that is 4 times a size of the one or more files.

In another aspect of the present disclosure, a method for monitoring dark web, analyzing one or more files downloaded from the dark web, and mitigating one or more data breaches caused by the downloaded one or more files is disclosed. The method includes downloading, by way of processing circuitry of a host device, one or more files by way of one or more file links. Further, the method includes generating, by way of the processing circuitry, an isolated environment by way of a virtual non-transitory computer-readable medium such that the one or more files are processed in the virtual non-transitory computer-readable medium. Furthermore, the method includes generating, by way of the processing circuitry a first mitigation signal when a data breach is detected, wherein based on the first mitigation signal (i) the virtual non-transitory computer-readable medium is compressed and encrypted and (ii) the generated isolated environment is deleted. Furthermore, the method includes generating, by way of the processing circuitry, a second mitigation signal when a data breach is not detected, wherein based on the second mitigation signal (i) the generated isolated environment is deleted and (ii) the virtual non-transitory computer-readable medium is deleted.

### BRIEF DESCRIPTION OF DRAWINGS

The drawing/s mentioned herein disclose exemplary aspects of the present disclosure. Other objects, features, and advantages of the present disclosure will be apparent from the following description when read with reference to the accompanying drawing.

FIG. 1 illustrates a block diagram of a system to monitor dark web, analyze one or more files downloaded from the dark web, and mitigate one or more data breaches caused by the downloaded one or more files, in accordance with an aspect of the present disclosure;

FIG. 2 is a block diagram that illustrates a processing unit of a host device of FIG. 1, in accordance with an aspect of the present disclosure; and

FIG. 3 is a flowchart that illustrates a method for monitoring dark web, analyzing one or more files downloaded from the dark web, and mitigating one or more data breaches caused by the downloaded one or more files, in accordance with an aspect of the present disclosure.

To facilitate understanding, like reference numerals have been used, where possible to designate like elements common to the figures.

### DETAILED DESCRIPTION OF PREFERRED ASPECTS

Various aspect of the present disclosure provides a system and a method for monitoring dark web, analyzing one or more files downloaded from the dark web, and mitigating one or more data breaches caused by the downloaded one or more files. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element is referred to as being “on,” “connected to,” or “coupled to” another element, it can be directly on, connected to, or coupled to the other element or intervening elements that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the presented subject matter might also be embodied in other ways, to include different features or combinations of features similar to the ones described in this document, in conjunction with other technologies.

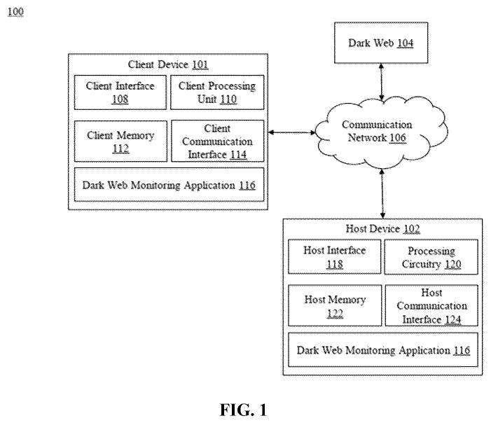

FIG. 1 illustrates a block diagram of a system 100 to monitor dark web, analyze one or more files downloaded from the dark web, and mitigate one or more data breaches caused by the downloaded one or more files, in accordance with an aspect of the present disclosure. The system 100 may be adapted to implement a dynamic air-gapped sandboxing technique, a custom authentication protocol, a secure file transfer mechanism, and an intelligent file processing technique to monitor dark web, analyze one or more files downloaded from the dark web, and mitigate one or more data breaches caused by the downloaded one or more files. Specifically, the system 100 may be configured to mitigate one or more risks associated with monitoring the dark web channels and further ensuring safety of a host system and providing a robust defense against emerging threats. The system 100 may be configured to establish a secure workflow encompassing safe file downloads, dynamic air-gapped sandbox creation, and secure data transfer and processing. The system 100 may include a client device 101 accessing the dark web 104 by way of a communication network 106 and/or through separate communication networks established therebetween. The system 100 may further include a host device 102 coupled to the client device 101 by way of the communication network 106 and/or through separate communication networks established therebetween.

The communication network 106 may include suitable logic, circuitry, and interfaces that may be configured to provide a plurality of network ports and a plurality of communication channels for transmission and reception of data related to operations of various entities in the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the client device 101 and/or the host device 102. The communication data may be transmitted and/or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

The client device 101 may be adapted to facilitate a user to input data, receive data, and/or transmit data within the system 100. In some aspects of the present disclosure, the client device 101 may be, but is not limited to, a desktop, a notebook, a laptop, a handheld computer, a touch sensitive device, a computing device, a smart phone, and the like. It will be apparent to a person of ordinary skill in the art that the client device 101 may be any device/apparatus that is capable of manipulation by the user. The client device 101 may have a client interface 108, a client processing unit 110, and a client memory 112. The client interface 108 may have an input interface for receiving inputs from the user. Examples of the input interface may be, but are not limited to, a touch interface, a mouse, a keyboard, a motion recognition unit, a gesture recognition unit, a voice recognition unit, or the like. Aspects of the present disclosure are intended to include or otherwise cover any type of the input interface including known, related art, and/or later developed technologies. The client interface 108 may further have an output interface for displaying (or presenting) an output to the user. Examples of the output interface may be, but are not limited to, a display device, a printer, a projection device, and/or a speaker, and the like. Aspects of the present disclosure are intended to include or otherwise cover any type of the output interface including known, related art, and/or later developed technologies.

The client processing unit 110 may be configured to execute various operations, such as one or more operations associated with the client device 101. In some aspects of the present disclosure, the client processing unit 110 may be configured to control one or more operations executed by the client device 101 in response to an input received at the client device 101 from a user. Examples of the client processing unit 110 may be, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Programmable Logic Control unit (PLC), and the like. Aspects of the present disclosure are intended to include or otherwise cover any type of the client processing unit 110 including known, related art, and/or later developed technologies. The client processing unit 110 may include suitable logic, circuitry, interfaces, and/or codes to perform one or more operations. For example, the client processing unit 110 may be configured to implement a bot. In some aspects of the present disclosure, the bot may be configured to continuously crawl one or more dark web channels to scrape information associated with one or more online forums, one or more marketplaces, stolen and/or breached data available on the dark web. In some aspects of the present disclosure, the information associated with the one or more online forums, one or more marketplaces, stolen and/or breached data available on the dark web may include, but is not limited to, a file link, a file name, a file size, a file protocol (i.e., file SYN), and the like. Specifically, the bot may be configured to utilize a load balancer that is equipped with a plurality of tor proxy engines. The plurality of tor proxy engines may be configured to implement a tor network such that the load balancer by way of the tor network distributes incoming network traffic across multiple servers while anonymizing user connection. Specifically, when a bot (i.e., the user) initiates a connection, the load balancer receives the request and forwards the request to a backend server based on predefined algorithms and/or rules. Simultaneously, the load balancer routes the traffic through the tor network, obscuring the user's original IP address and enhancing privacy and anonymity. The client processing unit 110 may be configured to identify the file links from the information associated with the one or more online forums, one or more marketplaces, stolen and/or breached data available on the dark web. Further, when the client processing unit 110 identifies the file links, the client processing unit 110 generates one or more handshake signals. Specifically, the one or more handshake signals comprising the file links along with the file name, the file size, and the file protocol (i.e., file SYN) associated with the file links.

The client memory 112 may be configured to store logic, instructions, circuitry, interfaces, and/or codes of the client processing unit 110, data associated with the host device 102, and data associated with the system 100. Examples of the client memory 112 may include, but are not limited to, a Read Only Memory (ROM), a Random Access Memory (RAM), a Flash Memory (FM), a Removable Storage Drive (RSD), a Hard Disk Drive (HDD), a Solid-State Memory (SSM), a Magnetic Storage Drive (MSD), a Programmable Read Only Memory (PROM), an Erasable PROM (EPROM), and/or an Electrically EPROM (EEPROM). Aspects of the present disclosure are intended to include or otherwise cover any type of the client memory 112 including known, related art, and/or later developed technologies.

The client device 101 may further have a client communication interface 114. The client communication interface 114 may be configured to enable the client device 101 to communicate with any other entity of the system 100 over the communication network 106. Examples of the client communication interface 114 may be, but are not limited to, a modem, a network interface such as an Ethernet Card, a communication port, and/or a Personal Computer Memory Card International Association (PCMCIA) slot and card, an antenna, a Radio Frequency (RF) transceiver, one or more amplifiers, a tuner, one or more oscillators, a digital signal processor, a Coder Decoder (CODEC) Chipset, a Subscriber Identity Module (SIM) card, and a local buffer circuit. It will be apparent to a person of ordinary skill in the art that the client communication interface 114 may have any device and/or apparatus capable of providing wireless and/or wired communications between the client device 101 and any other entity of the system 100.

The client device 101 may further include one or more computer executable applications such that the one or more suitable logics, circuitries, interfaces, and/or codes associated with the one or more computer executable applications may be stored in the client memory 122 and executed by the client processing unit 110. Examples of the one or more computer executable applications may include, but are not limited to, an audio application, a video application, a social media application, a navigation application, and the like. Preferably, the one or more computer executable applications may include a dark web monitoring application 116.

The host device 102 may be adapted to facilitate a user to input data, receive data, and/or transmit data within the system 100. In some aspects of the present disclosure, the host device 102 may be, but is not limited to, a desktop, a notebook, a laptop, a handheld computer, a touch sensitive device, a computing device, a smart phone, and the like. It will be apparent to a person of ordinary skill in the art that the host device 102 may be any device/apparatus that is capable of manipulation by the user. The host device 102 may have a host interface 118, processing circuitry 120, and a host memory 122. The host interface 118 may have an input interface for receiving inputs from the user. Examples of the input interface may be, but are not limited to, a touch interface, a mouse, a keyboard, a motion recognition unit, a gesture recognition unit, a voice recognition unit, or the like. Aspects of the present disclosure are intended to include or otherwise cover any type of the input interface including known, related art, and/or later developed technologies. The host interface 118 may further have an output interface for displaying (or presenting) an output to the user. Examples of the output interface may be, but are not limited to, a display device, a printer, a projection device, and/or a speaker, and the like. Aspects of the present disclosure are intended to include or otherwise cover any type of the output interface including known, related art, and/or later developed technologies.

The processing circuitry 120 may be configured to execute various operations, such as one or more operations associated with the host device 102. In some aspects of the present disclosure, the processing circuitry 120 may be configured to control one or more operations executed by the host device 102 in response to an input received at the host device 102. Examples of the host processing unit 110 may be, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Programmable Logic Control unit (PLC), and the like. Aspects of the present disclosure are intended to include or otherwise cover any type of the host processing unit 110 including known, related art, and/or later developed technologies.

The host memory 122 may be configured to store logic, instructions, circuitry, interfaces, and/or codes of the processing circuitry 120, data associated with the host device 102, and data associated with the system 100. Examples of the host memory 122 may include, but are not limited to, a Read Only Memory (ROM), a Random Access Memory (RAM), a Flash Memory (FM), a Removable Storage Drive (RSD), a Hard Disk Drive (HDD), a Solid-State Memory (SSM), a Magnetic Storage Drive (MSD), a Programmable Read Only Memory (PROM), an Erasable PROM (EPROM), and/or an Electrically EPROM (EEPROM). Aspects of the present disclosure are intended to include or otherwise cover any type of the host memory 122 including known, related art, and/or later developed technologies.

The host device 102 may further have a host communication interface 124. The host communication interface 124 may be configured to enable the host device 102 to communicate with any other entity of the system 100 over the communication network 106. Examples of the host communication interface 124 may be, but are not limited to, a modem, a network interface such as an Ethernet Card, a communication port, and/or a Personal Computer Memory Card International Association (PCMCIA) slot and card, an antenna, a Radio Frequency (RF) transceiver, one or more amplifiers, a tuner, one or more oscillators, a digital signal processor, a Coder Decoder (CODEC) Chipset, a Subscriber Identity Module (SIM) card, and a local buffer circuit. It will be apparent to a person of ordinary skill in the art that the host communication interface 124 may have any device and/or apparatus capable of providing wireless and/or wired communications between the host device 102 and any other entity of the system 100.

The host device 102 may further include one or more computer executable applications such that the one or more suitable logics, circuitries, interfaces, and/or codes associated with the one or more computer executable applications may be stored in the host memory 122 and executed by the processing circuitry 120. Examples of the one or more computer executable applications may include, but are not limited to, an audio application, a video application, a social media application, a navigation application, and the like. Preferably, the one or more computer executable applications may include the dark web monitoring application 116.

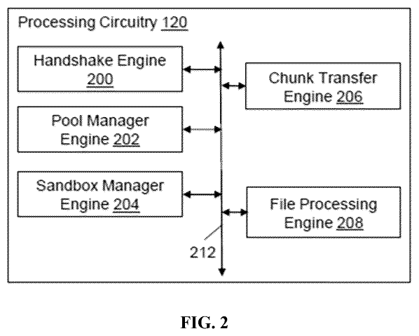

FIG. 2 is a block diagram that illustrates the processing circuitry 120 of the host device 102 of FIG. 1, in accordance with an aspect of the present disclosure. The processing circuitry 120 may include a handshake engine 200, a pool manager engine 202, a sandbox manager engine 204, a chunk transfer engine 206, and a file processing engine 208. The handshake engine 204, the pool manager engine 202, the sandbox manager engine 204, the chunk transfer engine 206, and the file processing engine 208 may communicate with each other by way of a communication bus 212. It will be apparent to a person having ordinary skill in the art that the processing circuitry 120 is for illustrative purposes and not limited to any specific combination of hardware circuitry and/or software.

The handshake engine 204 may include suitable logic, circuitry, interfaces, and/or codes to perform one or more operations. For example, the handshake engine 204 may be configured to facilitate establishment of a secure communication channel between the client device 101 and the host device 102. In other words, the handshake engine 204 may be configured to implement and execute an authentication protocol that ensures that only authorized entities can initiate file transfers and access the system 100, even in the face of a compromised host device. Specifically, the handshake engine 204 may be configured to enable a handshake between the client device 101 and the host device 102. To perform the handshake, the handshake engine 204 may be configured to receive the one or more handshake signals from the client device 101. In some aspects of the present disclosure, the one or more handshake signals may include a file name signal corresponding to the file name of the file link, a file size signal corresponding to the file size of the file associated with the file link, and a file protocol (i.e., file SYN) signal of the file protocol corresponding to the file associated with the file link. Upon reception of the one or more handshake signals, the handshake engine 200 may be configured to perform the handshake. Specifically, to perform the handshake, the handshake engine 200 may be configured to generate one or more acknowledgement signals to acknowledge the one or more handshake signals. Specifically, the one or more acknowledgement signals may include a file name ack signal corresponding to the file name signal, a file-size ack signal corresponding to the file size signal, and a file-syn ack signal corresponding to the file SYN signal. Further, the handshake engine 200 may be configured to generate a sandbox creation signal along with the generation of the one or more acknowledgement signals. Furthermore, the handshake engine 200 may be configured to provide the sandbox creation signal to the sandbox manager engine 204. Specifically, the sandbox creation signal may have information such as a memory requirement for creation of the isolated environment corresponding to the files associated with the file link. In some aspects of the present disclosure, the memory requirement for creation of the isolated environment corresponding to the files associated with the file link may be 4 times the file size of the files associated with the file link. In some aspects of the present disclosure, the handshake engine 200 may be further configured to define a sandbox socket address to the file link such that the handshake engine 204 provides the allocated sandbox address and the file link to the encryption engine 206.

The pool manager engine 202 may include suitable logic, circuitry, interfaces, and/or codes to perform one or more operations. For example, once the handshake is performed between the client device 101 and the host device 102, the pool manager engine 202 may be configured to implement a Look Up Table (LUT) and store the file links received from the client device 101.

The sandbox manager engine 204 may include suitable logic, circuitry, interfaces, and/or codes to perform one or more operations. For example, the sandbox manager engine 204 may be configured to receive the sandbox creation signal from the handshake engine 200. Specifically, the sandbox creation signal may be adapted to enable the sandbox manager engine 204 that may be configured to create an isolated environment within the host device 102 by creating and utilizing a virtual non-transitory computer-readable medium hosted on the host device 102. The virtual non-transitory computer-readable medium may have a size that is 4 times the file size of the files associated with the file link. Specifically, the isolated environment may be in isolation with the other entities of the host device 102. In some aspects of the present disclosure, the isolated environment may be dynamically created by the sandbox manager engine 204. Specifically, the sandbox manager engine 204 may be configured to create the virtual non-transitory computer-readable medium such that the virtual non-transitory computer-readable medium has stored thereon one or more software instructions to implement the file processing engine 208. In some preferred aspects of the present disclosure, the virtual non-transitory computer-readable medium may be tailored to specific size of the one or more files that may be saved and processed. The sandbox manager engine 204 may be further configured to generate an information signal that may include, but not limited to, a sandbox sock address. The sandbox manager engine 204 may be configured to provide the information signal to the chunk transfer engine 206.

The chunk transfer engine 206 may include suitable logic, circuitry, interfaces, and/or codes to perform one or more operations. For example, the chunk transfer engine 206 may be configured to enable downloading of one or more files from the file link. Specifically, the chunk transfer engine 206 may be configured to introduce a secure mechanism for downloading the one or more files from dark web channels. In some aspects of the present disclosure, the chunk transfer engine 206 may be configured to employ a robust method to ensure the safety of downloaded files, thus, preventing malicious content from compromising the host device 102. Specifically, the chunk transfer engine 206 may be configured to break the one or more files downloaded from the file link into a plurality of chunks. Further, the chunk transfer engine 206 may be configured to encrypt each chunk of the plurality of chunks by way of an asymmetric encryption technique to generate a plurality of encrypted chunks. Furthermore, the chunk transfer engine 206 may be configured to transmit the plurality of encrypted chunks (hereinafter referred to as “the encrypted chunks”) one by one to the virtual non-transitory computer-readable medium such that the encrypted chunks are processed by way of the file processing engine 208 in the isolated environment i.e., a sandbox. Specifically, the transmission of the plurality of chunks one by one to the virtual non-transitory computer-readable medium of the isolated environment may facilitate to minimize potential risks of host and data compromise during transit of the plurality of chunks.

The file processing engine 208 may include suitable logic, circuitry, interfaces, and/or codes to perform one or more operations. For example, the file processing engine 208 may be configured to receive the encrypted chunks. Further, the file processing engine 208 may be configured to decrypt the received encrypted chunks to generate corresponding decrypted chunks such that the decrypted chunks are assembled to generate the file (i.e., the file associated with the file link). Further, the file processing engine 208 may be configured to process the file. In some aspects of the present disclosure, for processing the file, the file processing engine 208 may be configured to decompress the file and further perform iterative keyword matching functions on the decompressed file. In some aspects of the present disclosure, when the file processing engine 208 detects a data breach based on the iterative keyword matching functions performed on the decompressed file, the file processing engine 208 generates a first mitigation signal. On the other hand, when the file processing engine 208 detects no data breach (i.e., data breach is not detected) based on the iterative keyword matching functions performed on the decompressed file, the file processing engine 208 generates a second mitigation signal. The file processing engine 208 may be further configured to provide the first and second mitigation signals to the sandbox manager engine 206. The first mitigation signal may enable the sandbox manager engine 206 that may be configured to compress the virtual non-transitory computer-readable medium. Further, the sandbox manager engine 206 may be configured to encrypt the virtual non-transitory computer-readable medium. Furthermore, the sandbox manager engine 206 may be configured to delete the isolated environment. Similarly, the second mitigation signal may enable the sandbox manager engine 206 that may be configured to delete the isolated environment. Further, the sandbox manager engine 206 may be configured to delete the virtual non-transitory computer-readable medium.

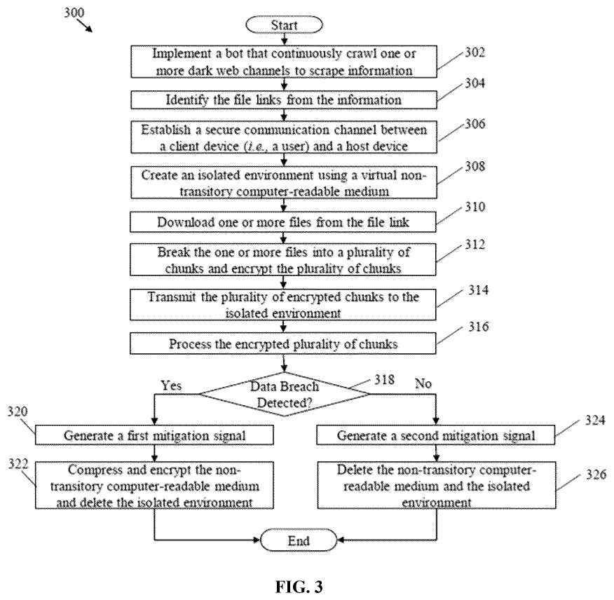

FIG. 3 is a flowchart that illustrates a method 300 for monitoring dark web, analyzing one or more files downloaded from the dark web, and mitigating one or more data breaches caused by the downloaded one or more files, in accordance with an aspect of the present disclosure.

At step 302, the system 100 by way of the bot running on the client device 101 may continuously crawl one or more dark web channels to scrape information associated with one or more online forums, one or more marketplaces, stolen and/or breached data available on the dark web.

At step 304, the system 100, by way of the client device 101, may identify the file links from the information associated with the one or more online forums, one or more marketplaces, stolen and/or breached data available on the dark web.

At step 306, the system 100, by way of the processing circuitry 120, may establish a secure communication channel between the client 101 and the host device 102. Specifically, the system 100, by way of the processing circuitry 120 may generate and transmit one or more acknowledgement signals to the client device 101 to perform handshake.

At step 308, the system 100, by way of the processing circuitry 120, may create an isolated environment by creating the virtual non-transitory computer-readable medium. In some aspects of the present disclosure, the isolated environment may be dynamically created.

At step 310, the system 100, by way of the processing circuitry 120, may download one or more files from the file link.

At step 312, the system 100, by way of the processing circuitry 120, may break the one or more files downloaded from the file link into a plurality of chunks. Further, the processing circuitry 120 may encrypt each chunk of the plurality of chunks by way of an asymmetric encryption technique.

At step 314, the system 100, by way of the processing circuitry 120, may transmit the plurality of encrypted chunks to the isolated environment one by one for processing.

At step 316, the system 100, by way of the processing circuitry 120, may decrypt the received encrypted chunks to generate corresponding decrypted chunks such that the decrypted chunks are assembled to generate the file (i.e., the file associated with the file link). Further, the processing circuitry 120 may decompress the file and perform iterative keyword matching functions on the decompressed file.

At step 318, the system 100, by way of the processing circuitry 120, may identify a status of the data breach. Specifically, when the processing circuitry 120 detects a data breach, the method 300 may proceed to a step 318. On the other hand, when the processing circuitry 120 detects no data breach (i.e., data breach is not detected), the method 300 may proceed to a step 322.

At step 320, the system 100, by way of the processing circuitry 120, may generate a first mitigation signal.

At step 322, the system 100, by way of the processing circuitry 120, may compress the virtual non-transitory computer-readable medium. Further, the processing circuitry 120 may encrypt the virtual non-transitory computer-readable medium. Furthermore, the processing circuitry 120 may delete the isolated environment.

At step 324, the system 100, by way of the processing circuitry 120, may generate a second mitigation signal.

At step 326, the system 100, by way of the processing circuitry 120, may delete the generated isolated environment. Further, the processing circuitry 120 may delete the virtual non-transitory computer-readable medium.

Thus, the system 100 and the method 300 of the present disclosure provides a dynamic air-gapped sandboxing solution by creating an isolated environment to process the plurality of encrypted chunks, a custom authentication protocol, secure file transfer mechanisms, and intelligent file processing. The system 100 and the method 300 of the present disclosure aims to mitigate the risks associated with monitoring dark web channels, ensuring the safety of the host device 102, and providing a robust defense against emerging threats. The system 100 focuses on establishing a secure workflow encompassing safe file downloads, dynamic air-gapped sandbox creation, and secure data transfer and processing.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each aspect. Rather, as the following aspects reflect, inventive aspects lie in less than all features of a single foregoing disclosed aspect, configuration, or aspect. Thus, the following aspects are hereby incorporated into this Detailed Description, with each aspect standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those disclosed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential. Certain terms are used throughout the following description and aspects to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure.

1. A system (100) comprising:
a client device (101);
a host device (102) that is coupled to the client device (101), the host device (102) comprising processing circuitry (120), the processing circuitry (120) is configured to:
download one or more files by way of one or more file links;
generate an isolated environment by way of a virtual non-transitory computer-readable medium such that the one or more files are received and processed in the isolated environment; and
generate:
a first mitigation signal when a data breach associated with the one or more files is detected, wherein based on the first mitigation signal (i) the virtual non-transitory computer-readable medium is compressed and encrypted and (ii) the generated isolated environment is deleted; and
a second mitigation signal when a data breach associated with the one or more files is not detected, wherein based on the second mitigation signal (i) the generated isolated environment is deleted and (ii) the virtual non-transitory computer-readable medium is deleted.

2. The system (100) of claim 1, wherein the processing circuitry (120) is configured to enable a handshake between the client device (101) and the host device (102), wherein to perform the handshake, the processing circuitry (120) is configured to (i) receive one or more handshake signals from the client device (101) and (ii) acknowledge the one or more handshake signals.

3. The system (100) of claim 1, wherein the client device (101) is configured to implement a bot that is configured to crawl one or more dark web channels to scrape information associated with one or more online forums, one or more marketplaces, stolen and/or breached data available on the dark web links.

4. The system (100) of claim 1, wherein prior to the transmission of the one or more files to the virtual non-transitory computer-readable medium, the processing circuitry (120) is configured to (i) break each file of the one or more files into a plurality of chunks, (ii) encrypt each chunk of the plurality of chunks by way of an asymmetric encryption technique to generate a plurality of encrypted chunks, and (iii) transfer each encrypted chunk of the plurality of encrypted chunks to the virtual non-transitory computer-readable medium one by one.

5. The system (100) of claim 1, wherein, to detect the data breach, the processing circuitry (120) is configured to (i) implement a file processing engine (208) by way of the virtual non-transitory computer-readable medium within the generated isolated environment, (ii) receive, by way of the file processing engine (208), the encrypted chunks, (ii) decrypt and assemble, by way of the file processing engine (208), the decrypted chunks into a file, and (iii) process, by way of the file processing engine (208), the file using file decompression and iterative keyword matching functions.

6. The system (100) of claim 1, wherein, to generate the isolated environment, the processing circuitry (120) is configured to create the virtual non-transitory computer-readable medium having a size that is 4 times a size of the one or more files.

7. A method (300) for monitoring dark web, analyzing one or more files downloaded from the dark web, and mitigating one or more data breaches caused by the downloaded one or more files, wherein the method (300) comprising:
downloading, by way of processing circuitry (120) of a host device (102), one or more files by way of one or more file links;
generating, by way of the processing circuitry (120), an isolated environment by way of a virtual non-transitory computer-readable medium such that the one or more files are processed in the virtual non-transitory computer-readable medium;
generating, by way of the processing circuitry (120):
a first mitigation signal when a data breach is detected, wherein based on the first mitigation signal (i) the virtual non-transitory computer-readable medium is compressed and encrypted and (ii) the generated isolated environment is deleted; and
a second mitigation signal when a data breach is not detected, wherein based on the second mitigation signal (i) the generated isolated environment is deleted and (ii) the virtual non-transitory computer-readable medium is deleted.

8. The method (300) of claim 7, wherein prior to the download of the one or more files, the method (300) comprising crawling, by way of a bot running on the client device (101), one or more dark web channels to scrape information associated with one or more online forums, one or more marketplaces, stolen and/or breached data available on the dark web links.

9. The method (300) of claim 1, wherein prior to the transmission of the one or more files to the virtual non-transitory computer-readable medium, the method (300) comprising (i) breaking, by way of the processing circuitry (120), each file of the one or more files into a plurality of chunks, (ii) encrypting, by way of the processing circuitry (120), each chunk of the plurality of chunks by way of an asymmetric encryption technique to generate a plurality of encrypted chunks, and (iii) transmitting, by way of the processing circuitry (120), each encrypted chunk of the plurality of encrypted chunks to the virtual non-transitory computer-readable medium one by one.

10. The method (300) of claim 1, wherein for detecting the data breach, the method (300) comprising (i) implementing, by way of the processing circuitry (120), a file processing engine (208) by way of the virtual non-transitory computer-readable medium within the generated isolated environment, (ii) receiving, by way of the file processing engine (208), the encrypted chunks, (ii) decrypting and assembling, by way of the file processing engine (208), the decrypted 10 chunks into a file, and (iii) processing, by way of the file processing engine (208), the file using file decompression and iterative keyword matching functions.
